(19) United States
(12) Patent Application Publication
(10) Pub. No.: US 2008/0225031 A1
(43) Pub. Date: Sep. 18, 2008

(54) COMMON VOLTAGE OUTPUT METHOD AND DISPLAY DEVICE UTILIZING THE SAME

(75) Inventors: Chun-Chin Tseng, Kaohsiung County (TW); Wen-Chen Fang, Tainan City (TW); Hsu-Ho Wu, Tainan City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HANNSTAR DISPLAY CORP., Tao-Yuan Hsien (TW)

(21) Appl. No.: 11/685,220

(22) Filed: Mar. 13, 2007

(51) Int. Cl. G09G 5/00

(52) U.S. Cl. 345/211

(57) ABSTRACT

A display device comprises a detection controller, common voltage generator and multilevel common voltage selecting circuit. The detection controller detects a display pattern of a display array to transmit a control signal. The common voltage generator generates first and second common voltages. The multilevel common voltage selecting circuit receives the first common voltage, the second common voltage, and the control signal and outputs the first common voltage and the second common voltage or only the first common voltage according to the control signal.

### BACKGROUND OF THE INVENTION

1. Field of the Invention

The invention relates to a display device, and in particular to a display device providing different voltages to a common electrode plate of a display array.

2. Description of the Related Art

FIG. 1 shows a conventional TFT LCD (Thin-Film Transistor Liquid Crystal Display) device 100. TFT LCD device 100 comprises source driving circuit 110, gate driving circuit 120 and display array 130. Display array 130 comprises a plurality of display units. For simplicity, FIG. 1 shows only display unit 141 comprising thin-film transistor 142, storage capacitor 143 and light emitting unit 144. Storage capacitor 143 and light emitting unit 144 are coupled to common voltage Vcom. Since each display unit of display array 130 has a different feed-through voltage based on the position thereof, each requires a different common voltage. FIG. 2 shows a relationship between the optimum common voltage and the display unit position. Referring to FIG. 1, based on measurement of a normal display array, the optimum common voltage V₁ at area A of display array 130 is often less than the optimum common voltage V₂ at area B of display array 130 and the optimum common voltage V₂ at area B of display array 130 is often less than the optimum common voltage V₃ at area C of display array 130, as shown in FIG. 2. If TFT LCD device 100 provides only one common voltage to each display unit of display array 130, flicker occurs on display array 130.

### BRIEF SUMMARY OF THE INVENTION

A display device comprises a common electrode plate, a display array corresponding to the common electrode plate, a timing controller detecting a display image of the display array and transmitting a control signal, a common voltage generator generating first and second common voltages, and a multilevel common voltage selecting circuit receiving the first common voltage, the second common voltage, and the control signal.

The common electrode plate comprises a first part common electrode plate and a second part common electrode plate. When the display shows a specific image, such as a computer shutdown screen, the multilevel common voltage selecting circuit outputs the first common voltage to the first part common electrode plate and the second common voltage to the second part common electrode plate. The display array comprises a plurality of display units coupled to the common electrode plate. The display units include first group display units and second group display units. The first part common electrode plate is coupled to the first group display units. The second part common electrode plate is coupled to the second group display units. The display device further comprises a source driving circuit providing a plurality of data signals to the display array and a gate driving circuit providing a plurality of scan signals to the display array. Each display unit comprises a switch, a light emitting unit, and a storage capacitor. The light emitting unit and the storage capacitor are coupled between the common electrode plate and the switch. The switch receives the data signal and the scan signal. The timing controller comprises a detection controller to detect the display image of the display array and transmits the control signal.

A method of outputting common voltage comprises providing a common electrode plate comprising a plurality of sub-common electrode plates, providing a display array corresponding to the common electrode plates, and determining whether a specific image is displayed.

When a specific image is displayed, such as a computer shutdown screen, a plurality of different common voltages are provided to the sub-common electrode plates and when the specific image is not displayed, a single common voltage is provided to the sub-common electrode plates.

### BRIEF DESCRIPTION OF THE DRAWINGS

The invention can be more fully understood by reading the subsequent detailed description and examples with references made to the accompanying drawings, wherein:

FIG. 1 shows a conventional thin-film transistor liquid crystal display device;

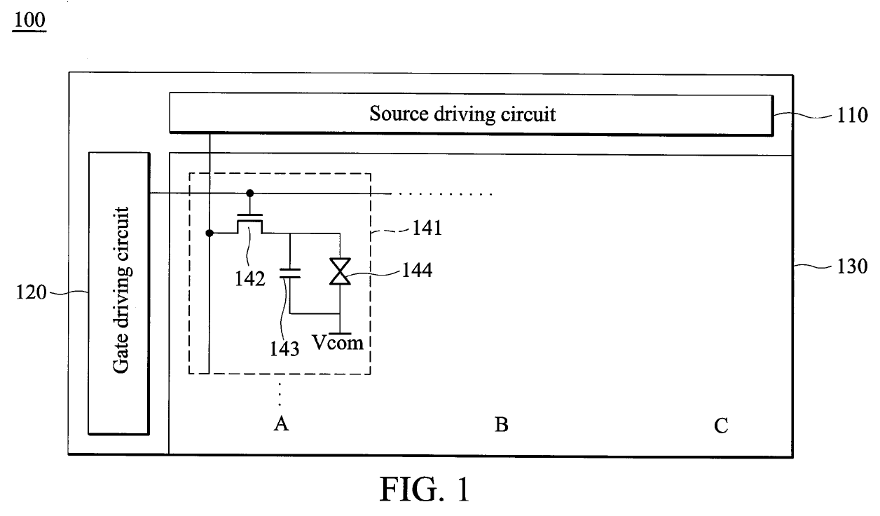

FIG. 2 shows a relationship between the optimum common voltage and the display unit position;

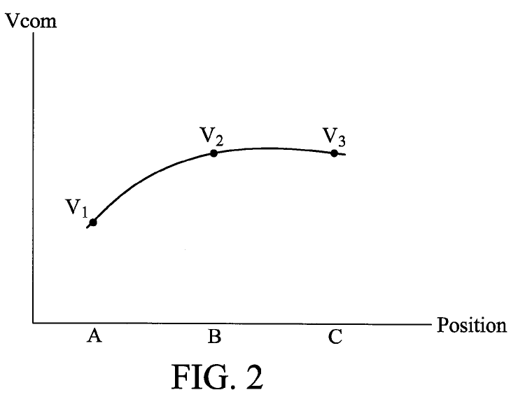

FIG. 3 shows a display device according to an embodiment of the invention; and

FIG. 4 is a flowchart of a common voltage output method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

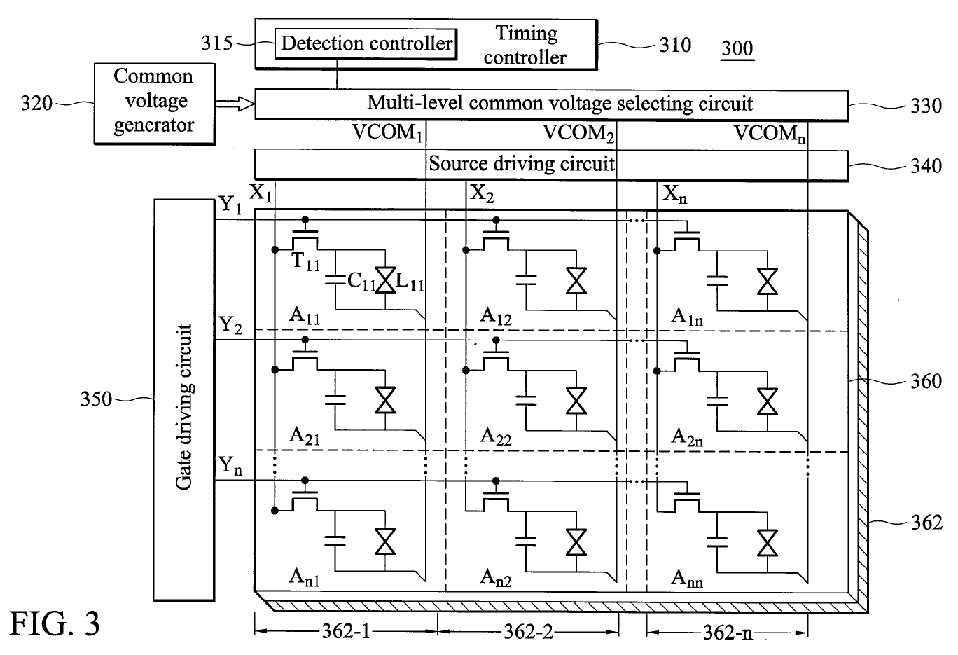

FIG. 3 shows display device 300 according to an embodiment of the invention, comprising timing controller 310, common voltage generator 320, multilevel common voltage selecting circuit 330, source driving circuit 340, gate driving circuit 350 and display array 360. Timing controller 310 comprises detection controller 315. Display array 360 comprises a plurality of display units A₁₁˜Aₙₙ. Each display unit comprises a switch, a storage capacitor, a light emitting unit. The storage capacitor and the light emitting unit of each display unit are coupled between the switch of each display unit and common electrode plate 362. Using display unit A₁₁ as an example, display unit A₁₁ comprises switch T₁₁, storage capacitor C₁₁ and light emitting unit L₁₁. Storage capacitor C₁₁ and light emitting unit L₁₁ are coupled between switch T₁₁ and common electrode plate 362. In addition, common electrode plate 362 comprises sub-common electrode plates 362-1, 362-2 . . . 362-n. Thus, display units A₁₁˜Aₙ₁ are coupled to sub-common electrode plate 362-1, display units A₁₂˜Aₙ₂ are coupled to sub-common electrode plate 362-2, and so on, accordingly.

When display device 300 receives display signals to display images, source driving circuit 340 provides a plurality of data signals through a plurality of source signal lines X₁˜Xₙ to each display unit A₁₁˜Aₙₙ of display array 360. Gate driving circuit 350 provides a plurality of scan signals through scan lines Y₁˜Yₙ to each display unit A₁₁˜Aₙₙ of display array 360. Because each display unit at a different position has a different optimum common voltage, common voltage generator 320 can provide a plurality of common voltages to multilevel common voltage selecting circuit 330. For instances, common voltage generator 320 can produce a plurality of common voltages, such as Vcom₁, Vcom₂ . . . Vcomₙ to multilevel common voltage selecting circuit 330. Then, multilevel common voltage selecting circuit 330 can respectively provide common voltages Vcom₁, Vcom₂ . . . Vcomₙ to different positioned display units to reduce the flicker on display array 360, and can also provide a single common voltage to each display unit A₁₁˜Aₙₙ according to the control signal from detection controller 315 When detection controller 315 detects a specific image on display array 360, such as a computer shutdown screen, detection controller 315 transmits a control signal to multilevel common voltage selecting circuit 330, driving the same to respectively output common voltages Vcom₁, Vcom₂ . . . Vcomₙ to different positioned display units. According to an embodiment of the invention, multilevel common voltage selecting circuit 330 respectively outputs common voltages Vcom₁, Vcom₂ . . . Vcomₙ to corresponding sub-common electrode plates 362-1, 362-2 . . . 362-n, as shown in FIG. 3. Thus, display units in different lines receive different level common voltages. When detection controller 315 detects no specific display image on display array 360, multilevel common voltage selecting circuit 330 only outputs a single common voltage to all sub-common electrode plates 362-1, 362-2 . . . 362-n according to the control signal of detection controller 315. Thus each display unit receives the same level common voltage.

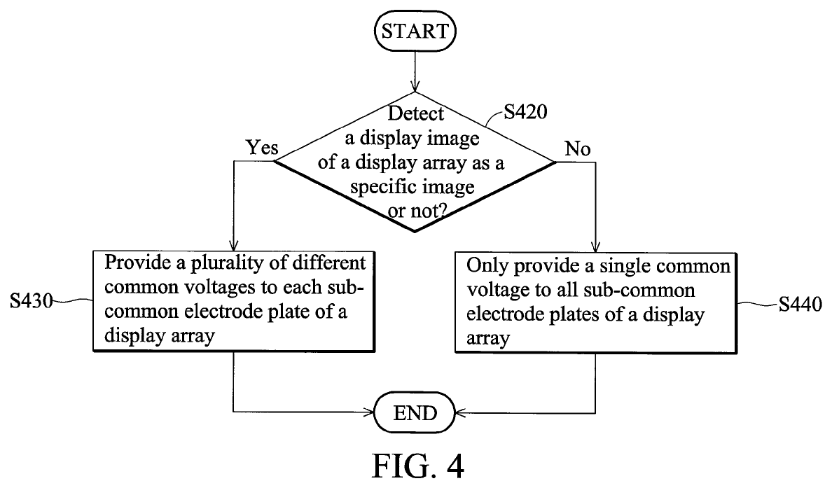

FIG. 4 is a flowchart of a common voltage output method according to an embodiment of the invention. Detection controller 315 detects a display image of display array 360 and transmits a control signal to multilevel common voltage selecting circuit 330 (step S420). When detection controller 315 detects a specific display image on display array 360, detection controller 315 transmits a control signal to multilevel common voltage selecting circuit 330, directing the same to respectively output common voltages Vcom₁, Vcom₂ . . . Vcomₙ to different positioned common electrodes (step S430) to reduce crosstalk on each display unit of display array 360. When detection controller 315 detects no specific display image on display array 360, multilevel common voltage selecting circuit 330 only outputs a single common voltage to all sub-common electrode plates 362-1, 362-2 . . . 362-n according to the control signal of detection controller 315. Thus, each display unit receives the same level common voltage.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display device, comprising:
a common electrode plate;
a display array corresponding to the common electrode plate;
a timing controller detecting a display image of the display array and transmitting a control signal;
a common voltage generator generating first and second common voltages; and
a multilevel common voltage selecting circuit receiving the first common voltage, the second common voltage, and the control signal.

2. The display device as claimed in claim 1, wherein the multilevel common voltage selecting circuit outputs the first common voltage to the common electrode plate according to the control signal.

3. The display device as claimed in claim 2, wherein when a specific image is displayed, the multilevel common voltage selecting circuit outputs the second common voltage to the common electrode plate.

4. The display device as claimed in claim 3, wherein the specific image is a computer shutdown screen.

5. The display device as claimed in claim 1, wherein the common electrode plate comprises a first part common electrode plate and a second part common electrode plate.

6. The display device as claimed in claim 5, wherein the multilevel common voltage selecting circuit outputs the first common voltage to the first part common electrode plate.

7. The display device as claimed in claim 5, wherein the multilevel common voltage selecting circuit outputs the second common voltage to the second part common electrode plate.

8. The display device as claimed in claim 1, wherein the display array comprises first group display units and second group display units.

9. The display device as claimed in claim 8, wherein the first part common electrode plate is coupled to the first group display units.

10. The display device as claimed in claim 8, wherein the second part common electrode plate is coupled to the second group display units.

11. The display device as claimed in claim 1, further comprising:
a source driving circuit providing a plurality of data signals to the display array; and
a gate driving circuit providing a plurality of scan signals to the display array.

12. The display device as claimed in claim 1, wherein the display array comprises a plurality of display units coupled to the common electrode plate.

13. The display device as claimed in claim 12, wherein each display unit comprises a switch, a light emitting unit, and a storage capacitor.

14. The display device as claimed in claim 13, wherein the light emitting unit and the storage capacitor are coupled between the common electrode plate and the switch.

15. The display device as claimed in claim 13, wherein the switch receives the data signal and the scan signal.

16. The display device as claimed in claim 1, wherein the timing controller comprises a detection controller to detect the display image of the display array and transmits the control signal.

17. A method of outputting common voltage, comprising:
providing a common electrode plate comprising a plurality of sub-common electrode plates;
providing a display array corresponding to the common electrode plate; and
determining whether a specific image is displayed.

18. The method of outputting common voltage as claimed in claim 17, wherein when a specific image is displayed, a plurality of different common voltages are provided to the sub-common electrode plates.

19. The method of outputting common voltage as claimed in claim 17, wherein when a specific image is not displayed, a single common voltage is provided to the sub-common electrode plates.

20. The method of outputting common voltage as claimed in claim 17, wherein the specific image is a computer shutdown screen.
